(19) United States
(12) Patent Application Publication
(10) Pub. No.: US 2020/0365841 A1
(43) Pub. Date: Nov. 19, 2020

(54) BATTERY CELL

(71) Applicant: Ningde Amperex Technology Ltd., Ningde (CN)

(72) Inventor: Wei Liang, Ningde (CN)

(21) Appl. No.: 16/533,909

(22) Filed: Aug. 7, 2019

(30) Foreign Application Priority Data
May 13, 2019 (CN) 201920682853.6

(51) Int. Cl. H01M 2/10; H01M 2/26

(52) U.S. Cl. CPC H01M 2/10; H01M 2/263

(57) ABSTRACT

A battery cell includes an electrode assembly and a first supporter. The electrode includes a planar area and a first thinned area. The first thinned area is thinner than the planar area. At least a portion of the first supporter is positioned in the electrode assembly. Thickness of the first supporter is gradually increased in a direction in which the thickness of the first thinned area decreases. The first supporter supports the first thinned area to compensate for difference in thickness so that the thickness of the battery cell is effectively uniform, thereby improving the performance of the battery cell, and safety and reliability of the battery cell.

### FIELD

The present disclosure herein generally relates to battery cells.

### BACKGROUND

For high specific capacity and energy, hundreds of layers of electrode plates are wound or laminated to form a battery cell. The difference in thickness between the edge area and the intermediate area of an electrode plate can amount to a millimeter or more. The thickness difference causes the thickness and the compaction density of the electrode plates to be uneven, thereby affecting the performance and safety factors of the battery cell. For example, the electrode plates can be inconsistent in expanding and contracting during charging and discharging, thereby affecting interface bonding of the edge area. This can cause battery capacity fluctuation and even lithium deposition.

Thus, there is room for improvement within the art.

### SUMMARY

A battery cell of the disclosure includes an electrode assembly, and the electrode assembly includes a planar area. A first thinned area is also included, the thickness of the first thinned area is less than the thickness of the planar area, and the thickness of the thinned area is gradually reduced in a direction. The battery cell further includes a first supporter, at least a portion of the first supporter is positioned in the first thinned area. The thickness of the portion of the first supporter is substantially increased.

Furthermore, the first supporter includes a first surface, the first surface is in contact with the first thinned area, and the first surface is a flat surface.

Furthermore, the first supporter further includes a second surface, the second surface is in contact with the first thinned area, and an acute angle is defined between the first surface and the second surface.

The first surface of the first supporter may be a curved surface.

The second surface of the first supporter may be a curved surface or a flat surface.

The first surface and the second surface of the first supporter are symmetrical.

Furthermore, electrode assembly includes a separator and an electrode plate, the first supporter is located at a side portion of the electrode plate. Along the thickness reducing direction of the first thinned area, an outermost side of the first supporter is located between an outermost side of the separator and an outermost side of the electrode plate.

The battery cell further includes a connecting body, the connecting body is positioned in the electrode assembly, and the connecting body is in contact with the planar area of the electrode assembly. A thickness of the connecting body is not less than a minimum thickness of the first supporter, and the thickness of the connecting body is smaller than a maximum thickness of the first supporter.

The connecting body and the first supporter are an integral structure.

The battery cell further includes a second thinned area and a second supporter. The second supporter is positioned in the electrode assembly, and a thickness of the second thinned area is less than a thickness of the planar area. The second supporter is in contact with the second thinned area. The thickness of the second supporter is gradually increased in the direction that thickness of the thinned area decreases.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric and structural diagram of a battery cell in a first embodiment.

FIG. 2 is a cross-sectional view of the battery cell of FIG. 1.

FIG. 3 is a side view of the battery cell of the first embodiment.

FIG. 4A-FIG. 4E are isometric view of a first supporter of the battery cell in different embodiments.

FIG. 5 is an isometric view and structural diagram of a battery cell in a second embodiment.

FIG. 6 is an isometric view and structural diagram of a battery cell in a third embodiment.

FIG. 7 is an isometric view of a first supporter of the battery cell of FIG. 6.

### DETAILED DESCRIPTION

The present application will be described with reference to the accompanying drawings. A number of details are set forth in the following description so as to fully understand the present application. However, the present application can be implemented in many other ways different from those described herein, and those skilled in the art can make improvements without violating the contents of the present application. Therefore, the present application is not to be considered as limiting the scope of the embodiments described herein.

Unless otherwise defined, all technical and scientific terms used herein have the same meaning as commonly understood by one skilled in the art. The terms used in specification of the present application herein are only for describing specific embodiments, and are not intended to limit the present application.

### First Embodiment

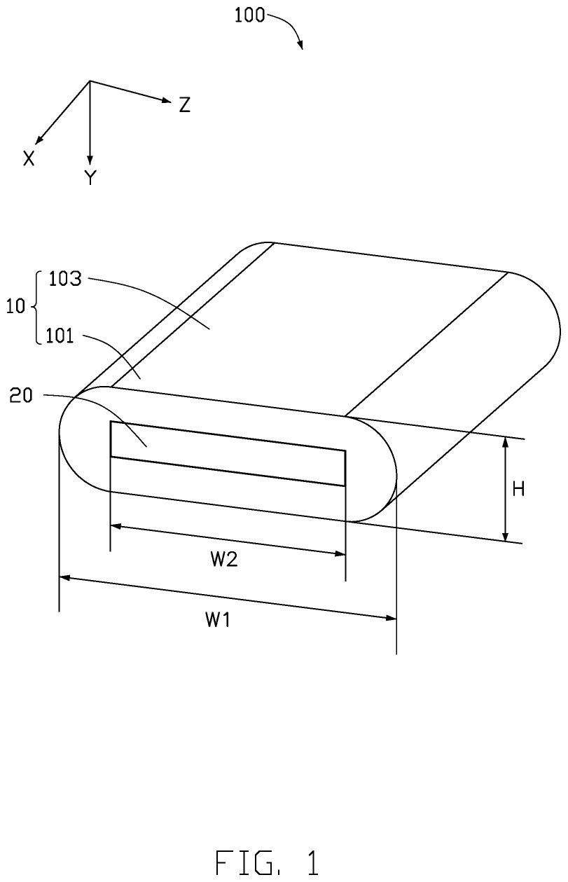

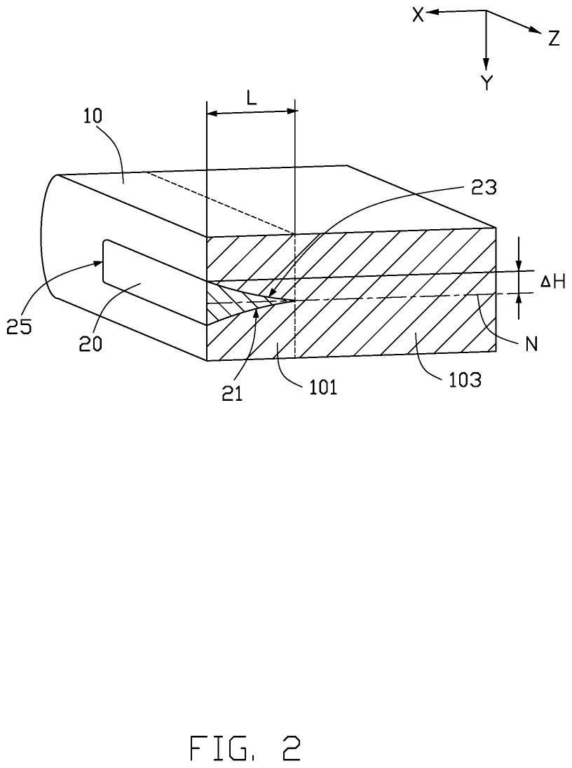

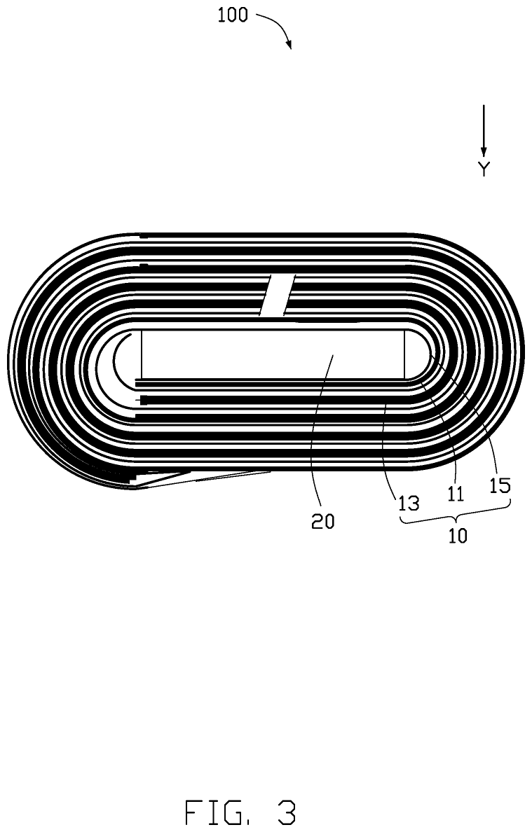

Referring to FIG. 1 and FIG. 2, a battery cell 100 can include an electrode assembly 10 and a first supporter 20. At least a portion of the first supporter 20 is positioned in the electrode assembly 10. The electrode assembly 10 includes an electrode plate, which is coated and winded around the first supporter 20 (see FIG. 3), and electrode tabs of the cell are positioned, but not limited to, at a single-side. In a coating process of the battery cell 100, an edge thinning effect causes a thickness of edge portion of the electrode plate's coating along a long edge is less than a thickness of intermediate portion, for example, by several micrometers. Therefore, the electrode assembly 10 includes a first thinned area 101 and a planar area 103, and the thickness of the first thinned area 101 is less than the thickness of the planar area 103, and the thickness of the thinned area 101 is gradually reduced in a direction. In other embodiments, the battery cell 100 can also be a laminated battery cell, in which some electrode plates are laminated together. Referring to FIG. 1, in order to clarify the subsequent description, a first direction X is defined as a thickness decreasing direction of the first thinned area 101, a second direction Y is parallel to the thickness direction of the electrode assembly 10, and a third direction Z is parallel to the width direction of the electrode assembly 10. The first direction X, the second direction Y, and the third direction Z are perpendicular to each other. The electrode assembly 10 illustrated in FIGS. 1-2, and 5-6 is merely an overall structural diagram, and details of composition of the structure is not shown.

Referring to FIG. 2, the thickness of the first supporter 20 is gradually increased in the first direction X. Specifically, the portion of the first supporter 20 in the first thinned area 101 is gradually increased in the first direction X. The first supporter 20 supports the first thinned area 101 to compensate the thickness differences between the first thinned area 101 and the planar area 103. Therefore, the thickness of the electrode assembly 10 is able to be uniform, improving the performance of the battery cell 100, safety and reliability of the battery cell 100 are improved.

Referring to FIG. 3, the electrode assembly 10 includes a first electrode plate 11, a second electrode plate 13, and a separator 15. The first electrode plate 11 and the second electrode plate 13 have opposite polarities. In the second direction Y, the separator 15 is located between and isolates the first electrode plate 11 and the second electrode plate 13. The separator 15, the first electrode plate 11, and the second electrode plate 13 are wound, to form the electrode assembly 10. The first supporter 20 is inserted in the electrode assembly 10, and the first supporter 20 is located between or surrounded by the first electrode plate 11 and the second electrode plate 13. The first supporter 20 is located at a side portion of the electrode assembly 10. The separator 15 surrounds the first supporter 20, and is in contact with the first supporter 20.

Specifically, the first support 20 is positioned at the innermost layer of the electrode assembly 10, and is surrounded by the separator 15. The first supporter 20 is contact with and bounded, but not limited to, to the separator 15 by high temperature process. In other embodiments, the first supporter 20 may also be fixed by an adhesive layer between the separator 15 and the first supporter 20. Both of these means of fixing are within the “contact” range. The supporter appearing at other positions is in contact with the electrode assembly. Methods of contact of the supporter and the electrode assembly include at least direct contact and indirect contact by a bonding layer.

In the first direction X, the outermost side of the first supporter 20 extends out of the outermost sides of the first electrode plate 11 and the second electrode plate 13, so that the first supporter 20 can support the whole first electrode plate 11 and the second electrode plate 13. In the first direction X, the outermost side of the separator 15 extends out of the outermost side of the first supporter 20, so that the first supporter 20 does not make contact with the first electrode plate 11 and the second electrode plate 13. Thus the first supporter 20 is prevented from damaging the first electrode plate 11 and the second electrode plate 13.

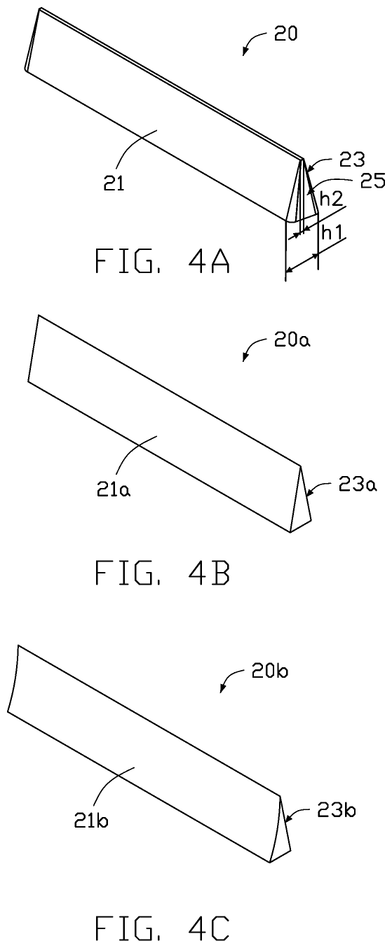

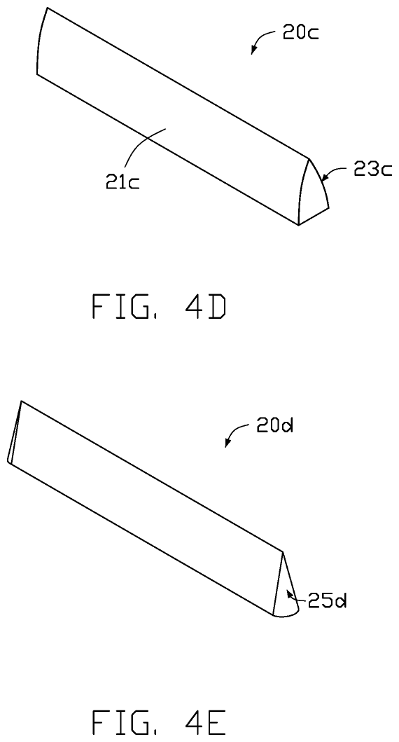

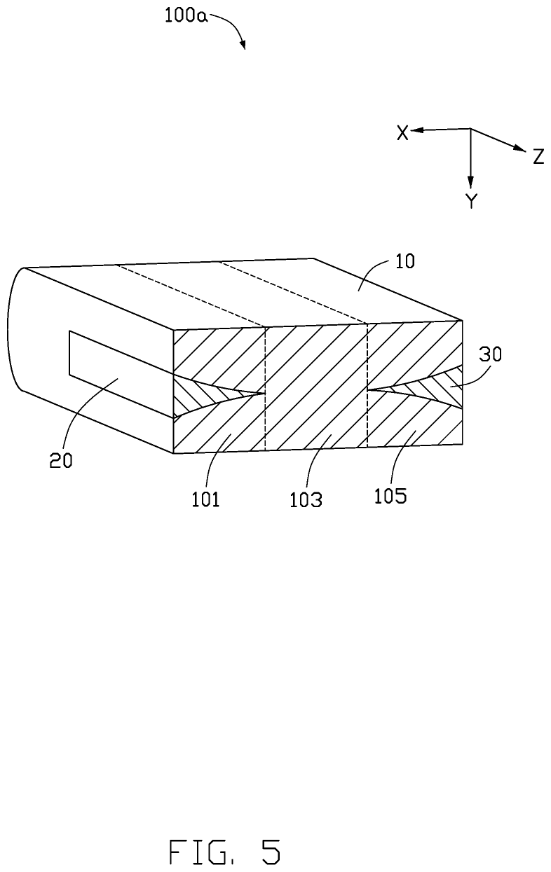

Referring to FIG. 2 and FIG. 4A, the first supporter 20 includes a first surface 21 and a second surface 23 opposite to the first surface 21 in the second direction Y. The first surface 21 and the second surface 23 both contact the first thinned area 101. The first surface 21 and the second surface 23 are, but not limited to, curved surfaces and symmetrical. The first support 20 is located at the innermost layer of the electrode assembly 10, and the first surface 21 and the second surface 23 of the first support 20 support the first thinned area 101 of the electrode assembly 10. Thickness of the first thinned area 101 and stresses applied on the first thinned area 101 are able to be uniform. The battery cell 100 is evenly stressed during the expansion and contraction of charging and discharging for having a uniform thickness, that solves the safety problems, such as battery capacity fluctuation and even lithium deposition caused by the edge thinning effect.

Referring to FIG. 2, the first supporter 20 further includes two third surfaces 25 opposite to each other in the third direction Z. The third surfaces 25 are in contact with the first surface 21 and the second surface 23 in arcuate transition. The third surface 25 can be, but not limited to, a flat surface.

Referring to FIG. 4B, in another embodiment, another supporter (first supporter 20a) is provided. The first supporter 20a has substantially the same structure as the first supporter 20, except that the first supporter 20a includes a first surface 21a and a second surface 23a oppositely disposed in the second direction Y. The first surface 21a and the second surface 23a are both a flat surface, and an acute angle is defined between the first surface 21a and the second surface 23a, so that the cross section of the first support 20a along the first direction X is gradually increased. A right angle, but not limited to, is defined between the third surface 25 (shown in FIG. 4A) and the first surface 21a.

Referring to FIG. 4C, in another embodiment, another supporter (first supporter 20b) is provided. First supporter 20b is substantially the same in structure to the first supporter 20, except that the first supporter 20b includes a first surface 21b and a second surface 23b oppositely disposed in the second direction Y. The first surface 21b is a curved surface, and the second surface 23b is a flat surface.

Referring to FIG. 4D, in another embodiment, another supporter (first supporter 20c) is provided. First supporter 20c is substantially the same in structure to the first supporter 20, except that the first supporter 20c includes a first surface 21c and a second surface 23c oppositely disposed in the second direction Y. The first surface 21c and the second surface 23c are curved surfaces.

Referring to FIG. 4E, in another embodiment, another supporter (first supporter 20d) is provided. First supporter 20d has substantially the same structure as the first supporter 20, except that the first supporter 20d includes two third surfaces 25d oppositely disposed in the third direction Z. The third surface 25d can be, but not limited to a convex surface. In other embodiments, the third surface 25d may also be a plane or a curved surface according to variation of the width of the electrode assembly 10 in the third direction Z.

The portion of the first supporter 20 in contact with the first thinned area 101 has the greatest thickness h1 and the least thickness h2, as shown in FIG. 4A. The distance between the innermost side of the thinnest portion of the first thinned area 101 and the symmetry plane N of the electrode assembly 10 along the first direction X is ΔH, as shown in FIG. 2. The difference between the thickness h2 of the first thinned area 101 and the thickness h1 of the planar area 103 is 2*ΔH. Values of h1, h2, and ΔH satisfy equation h1-h2<0.9*2*ΔH, which leaves a space for expansion of the battery cell 100 during charging and discharging. The range of ΔH is generally from 1.5 mm to 4.5 mm.

As the number of layers of the electrode assembly 10 is increased, the problems caused by edge thinning become more serious. The number of winding turns or the number of laminated layers of the battery cell 100 is generally greater than 15.

Referring to FIG. 1, in the third direction Z, the battery cell 100 has a width W1 and a thickness H, and the first support 20 has a width W2. Values of W1, W2, and H satisfy equation W2<W1−H, so that the first support 20 is able to be arranged into the electrode assembly 10, and can support the electrode assembly 10 in the third direction Z.

Referring to FIG. 2, along the first direction X, a contacting length L of the first supporter 20 and the first thinned area 101 is determined according to the width of the first thinned area 101. Absolute value of difference between the first supporter 20 and the first thinned area 101 does not exceed 10% of the width of the first thinned area 101. Furthermore, when the width of the first thinned area 101 does not exceed 20 mm, the length L of the first supporter 20 in contact with the first thinned area 101 satisfies 0<L≤20 mm. Additionally, when the width of the first supporter 20 is less than 5 mm, preparation and assembly process becomes more difficult, and the narrower that the first thinned area 101 is, the higher is the energy density of the battery. Therefore, the length L is preferably 5≤L≤10 mm.

There's no chemical reactions between the first supporter 20 and the electrolyte (not shown) in the battery cell 100. In the first embodiment, the material of the first supporter 20 is a resin, and the elastic modulus E of the first supporter 20 satisfies, but not limited to, 0.8 Gpa<E<3.92 GPa. The first support 20 can be made of a rigid or flexible material. The first supporter 20 is made of a high hardness material such as PS or ABS to enhance the rigidity of the battery cell 100 and reduce any deformation of the battery cell 100. In other embodiments, the first supporter 20 can also be made of a low hardness material such as PE, PP, or PA.

Coatings of the first electrode plate 11 and the second electrode plate 13 are uneven surfaces in microscopic observation. Correspondingly, the first surface 21, the second surface 23 and the third surface 25 of the first supporter 20 in contact with the first thinned area 101 may also be uneven surfaces in microscopic observation.

### Second Embodiment

Referring to FIG. 5, a battery cell 100a includes substantially the same structure as that of the battery cell 100 in the first embodiment, except that electrode tabs of the battery cell 100a are positioned at both sides of the battery cell 100a. The battery cell 100a further includes a second thinned area 105 and a second support 30 arranged in the electrode assembly 10. The thickness of the second thinned area 105 is less than the thickness of the planar area 103 of the electrode assembly 10. The second supporter 30 is in contact with the second thinned area 105. The thickness of the second supporter 30 gradually increases in a direction opposite to the first direction X. The second supporter 30 supports the second thinned area 105 to compensate thickness difference between the second thinned area 105 and the planar area 103, so that the thickness of the electrode assembly 10 is able to be uniform, thereby improving the performance of the battery cell 100a, safety and reliability of the battery cell 100a are improved.

### Third Embodiment

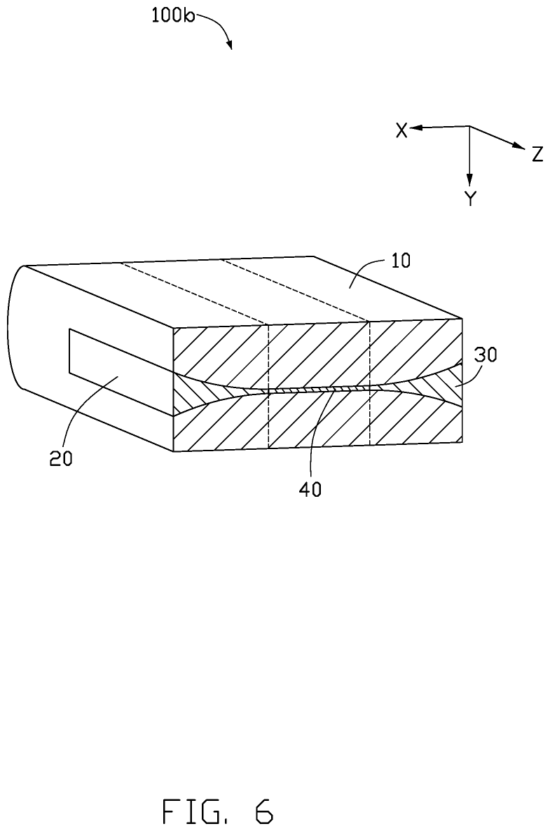

Referring to FIG. 6, a battery cell 100b includes substantially the same structure of the battery cell 100a of the second embodiment, except that the battery cell 100b further includes a connecting body 40. The connecting body 40 is arranged in the electrode assembly 10, and is in contact with the planar area 103 of the electrode assembly 10. The first supporter 20 and the second supporter 30 are positioned at sides of the connecting body 40.

Along the first direction X, the thickness of the connecting body 40 is not less than the minimum thickness of the first supporting body 20 and the second supporting body 30, and the thickness of the connecting body 40 is smaller than the first supporting body 20 or the maximum thickness of the second support 30.

The connecting body 40, the first supporter 20, and the second supporter 30 are split in structure and made of the same material. The connecting body 40 is connected or abutted to the first supporter 20 and the second supporter 30. The separator 15 surrounds and is connected to, but not limited to, the connecting body 40. The connecting body 40 prevents the first supporter 20 and the second supporter 30 from moving the separator 15 relative to the first electrode plate 11 or the second electrode plate 13.

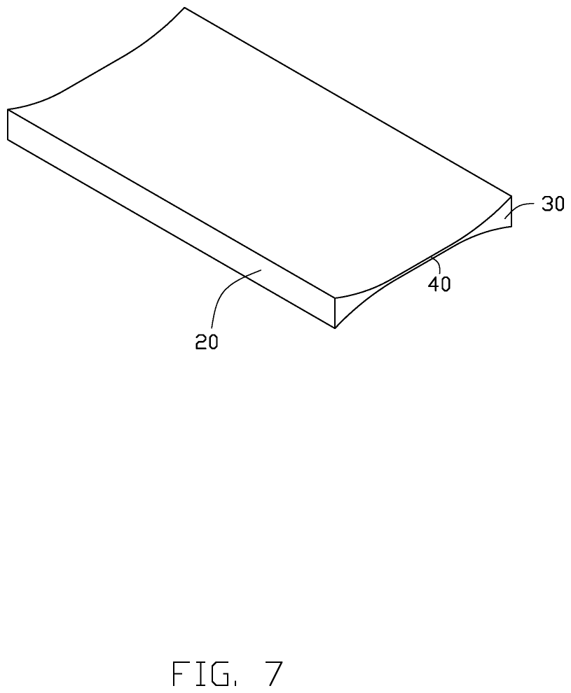

Referring to FIG. 7, in another embodiment, the connecting body 40, the first supporter 20, and the second supporter 30 are integrally formed structures. The first supporter 20 and the second supporter 30 are connected to the separator 15. The connecting body 40 is not connected to the separator 15.

In other embodiments, sides the first supporter 20 and the second supporter 30 may also extend out of the electrode assembly 10 for supporting other external structures, that is, a portion of the first supporter 20 and the second supporter 30 is positioned in the electrode assembly 10. Thickness of the portion of the first supporter 20 and the second supporter 30 positioned in the electrode assembly 10 are gradually increased along the first direction X.

By combining the first to third embodiments, the thickness of the first supporter 20 is gradually increased along the thickness decreasing direction of the first thinned area 101, which is defined as the first direction X. The first supporter 20 supports the first thinned area 101 to compensate the thickness difference between the first thinned area 101 and the planar area 103, so that the thickness of the battery cell 100 is able to be uniform, thereby improving the performance of the battery cell 100, safety and reliability of the battery cell 100 are improved.

A method for distinguishing between the thinned area and the planar area in this application is that a thickness of the battery cell is measured by a small micrometer. The diameter of a testing head is 1 mm, and the testing head is fixed, and points at every 1 mm are measured. When there are three consecutive testing points, where thicknesses testing value satisfy T1>T2>T3 (T1, T2, T3 are the thicknesses testing value of three testing points), T1-T2<T2-T3, and T1-T2≥10 um defines the position of T1 as a starting point of the thinned area. The same method can be used to define other starting positions for the thinned area. Conversely, if there're ten testing points are continuously performed, and the difference between the thicknesses of the thickest and thinnest test points is less than 10 um, the area where the ten points are located is considered to be a planar area.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A battery cell, comprising:
an electrode assembly, comprising:
a planar area; and
a first thinned area with a thickness less than a thickness of the planar area, and the thickness of the first thinned area is gradually reduced in a direction; and
a first supporter;
wherein at least a portion of the first supporter is positioned in the first thinned area, and the thickness of the portion of the first supporter is gradually increased in the direction.

2. The battery cell of claim 1, wherein, the first supporter comprises a first surface, the first surface is in contact with the first thinned area, and the first surface is a flat surface.

3. The battery cell of claim 2, wherein, the first supporter further comprises a second surface, the second surface is in contact with the first thinned area, and an acute angle is defined between the first surface and the second surface.

4. The battery cell of claim 3, wherein, the first supporter further comprises a third surface in contact with the first surface and the second surface, the third surface is a flat surface, and a right angle defined between the third surface and the first surface.

5. The battery cell of claim 1, wherein, the first supporter comprises a first surface, and the first surface is a curved surface and in contact with the first thinned area.

6. The battery cell of claim 5, wherein, the first supporter comprises a second surface, and the second surface is a curved surface or a flat surface and in contact with the first thinned area.

7. The battery cell of claim 5, wherein, the first supporter further comprises a second surface, the second surface is in contact with the first thinned area, and the first surface and the second surface are symmetrical.

8. The battery cell of claim 2, wherein, the first supporter further comprises a second surface, the second surface is in contact with the first thinned area, and the first surface and the second surface are symmetrical.

9. The battery cell of claim 1, wherein, the electrode assembly comprises a separator, a first electrode plate, and a second electrode plate, the first supporter is located between or surrounded by the first electrode plate and the second electrode plate, and the separator is positioned between the first electrode plate and the second electrode plate.

10. The battery cell of claim 9, wherein, the separator, the first electrode plate, and the second electrode plate are wound to form the electrode assembly.

11. The battery cell of claim 9, wherein, the separator is in contact with the first supporter.

12. The battery cell of claim 9, wherein, an outermost side of the first supporter extends out of outermost sides of the first electrode plate and the second electrode plate.

13. The battery cell of claim 12, wherein, along the thickness reducing direction of the first thinned area, an outermost side of the separator extends out of the outermost side of the first supporter.

14. The battery cell of claim 1, wherein, the battery cell further comprises a connecting body, the connecting body is positioned in the electrode assembly, and the connecting body is in contact with the planar area of the electrode assembly; and a thickness of the connecting body is not less than a minimum thickness of the first supporter, and the nor more than thickness of the connecting body is smaller than a maximum thickness of the first supporter.

15. The battery cell of claim 14, wherein, the connecting body and the first supporter are integrally formed structures.

16. A battery cell, comprising:
an electrode assembly, comprising:
a planar area; and
a first thinned area with a thickness less than a thickness of the planar area, and the thickness of the first thinned area is gradually reduced in a direction; and
a first supporter;
wherein at least a portion of the first supporter positioned in the first thinned area, and the thickness of the portion of the first supporter is gradually increased in the direction; and
wherein, the battery cell further comprises a second thinned area and a second supporter, the second supporter is positioned in the electrode assembly, and a thickness of the second thinned area is less than a thickness of the planar area; the second supporter is in contact with the second thinned area; and the thickness of the second supporter is gradually increased in a direction that the thickness of the second thinned area decreases.

17. The battery cell of claim 16, wherein, the battery cell further comprises a connecting body, the connecting body is positioned in the electrode assembly, and the connecting body is in contact with the planar area of the electrode assembly; and a thickness of the connecting body is not less than a minimum thickness of the first supporter, and the thickness of the connecting body is smaller than a maximum thickness of the first supporter.

18. The battery cell of claim 17, wherein, the connecting body and the first supporter are integrally formed structures.

19. The battery cell of claim 17, wherein, the connecting body, the first supporter, and the second supporter are split in structure and made of the same material; and the first supporter and the second supporter are positioned at sides of the connecting body.
